(19) United States
(12) Patent Application Publication
(10) Pub. No.: US 2017/0074391 A1
(43) Pub. Date: Mar. 16, 2017

(54) ROTATABLE VEHICLE TRANSMISSION SHIFTER APPARATUS

(71) Applicant: GHSP, Inc., Grand Haven, MI (US)

(72) Inventor: Charles Bernard Tebbe, Holland, MI (US)

(21) Appl. No.: 15/266,431

(22) Filed: Sep. 15, 2016

Related U.S. Application Data
(60) Provisional application No. 62/219,216, filed on Sep. 16, 2015.

(51) Int. Cl. F16H 59/08; F16H 61/22

(52) U.S. Cl. CPC F16H 59/08; F16H 61/22; F16H 2059/081; F16H 2059/0295

(57) ABSTRACT

The apparatus comprises a selection knob rotatable between angular positions for selecting an operating mode P, R, N, D of the transmission controller; and a knob-rotation-control mechanism configured to engage and hold the knob in the angular positions; and to move the knob automatically back to a desired (park) position when particular vehicle conditions are met. In first embodiment, a reversible motor operably coupled with the knob-rotation-control mechanism is configured to slidingly move the knob-rotation-control mechanism between a locked position that prevents knob rotation, an unlocked position that allows knob rotation and gear selection, and a second unlocked position (with feel positioner released) for automatic return to the gear position when predetermined vehicle conditions are met. In another embodiment, a reversible motor and a linear actuator provide coordinated operation to accomplish a similar result as the first embodiment.

This application claims benefit under 35 USC section 119(e) to U.S. Provisional Application No. 62/219,216, filed on Sep. 16, 2015, entitled ROTATABLE VEHICLE TRANSMISSION SHIFTER APPARATUS the entire disclosure of which is incorporated herein by reference.

### BACKGROUND

The present invention relates to vehicle transmission shifters for controlling shifting of gears in vehicle transmissions, and more particularly relates to a rotatable shifter with features facilitating a compact assembly of small size, low noise, and reliable operation.

Rotary shifters for shifting passenger vehicle transmissions are known. For example, see US Patent Publication Fett 2015/0167827 published Jun. 18, 2015. However, further improvements are desired, such as further-reduced size, further-reduced noise of operation, simplification of components and parts, and more integrated designs leading to more robust and longer-lasting systems.

### SUMMARY OF THE PRESENT INVENTION

In one aspect of the present invention, a shifter apparatus for operating a transmission controller of a vehicle, comprises a selection knob rotatable between a plurality of angular positions for selecting an operating mode of the transmission controller; a knob-rotation-control mechanism configured to engage the selection knob in at least one of the plurality of angular positions; and a motor operably coupled with the knob-rotation-control mechanism and configured to slide a portion of the knob-rotation-control mechanism between at least two positions including a locked position that prevents rotation of the selection knob and an unlocked position that allows rotation of the selection knob.

In narrower aspects, the shifter includes a feel positioner. Also, the portion of the knob-rotation-control mechanism includes at least one gear that slides translatingly along a track between the knob locked position, a (partially-moved) knob unlocked position, and a (fully-moved) knob unlocked position. The slidable gear, in at least one of the unlocked positions, allows the knob to be rotated automatically back to park without the feel positioner being engaged.

In another aspect of the present invention, a shifter apparatus for operating a transmission controller of a vehicle for shifting a vehicle transmission between gear positions comprises a selection knob rotatable between a plurality of angular positions for selecting an operating mode of the transmission controller. The operating mode controls selection of a desired one of the gear positions, and a knob-rotation-control mechanism is configured to engage the selection knob in at least one of the plurality of angular positions. At least two actuators are operably coupled with the knob-rotation-control mechanism and configured to rotate the knob-rotation-control mechanism between at least two positions including a locked position that prevents rotation of the selection knob and an unlocked position that allows rotation of the selection knob.

In another aspect of the present invention, a shifter apparatus for operating a transmission controller to shift a transmission of a vehicle and to operate the shifter apparatus when a particular condition is sensed, comprises a selection knob rotatable between a first angular position (e.g. R, N, D) and a second angular position (e.g. P) that correspond respectively with a first operating mode and a second operating mode of the transmission controller; and at least one actuator operably coupled with the selection knob and configured to automatically rotate the selection knob from the first angular position to the second angular position when the particular condition is present.

In a narrower form, the shifter includes a feel positioner that provides a feel (i.e. that provides increasing and decreasing amounts of resistance to rotation to give the vehicle operator a sense of the center of selected gear angular positions) to a vehicle operator that the shifter's knob is in a desired (P, R, N, or D) angular position. The at least one actuator also is adapted to release the feel positioner during the automatic movement to facilitate smooth rotation without increasing and decreasing amounts of resistance to rotation from the feel positioner.

In another aspect of the present invention, a shifter apparatus for operating a transmission controller to shift a transmission of a vehicle and to operate the shifter apparatus when a particular condition is sensed, comprises a selection knob rotatable between park, reverse, neutral, and drive (P, R, N, D) gear positions associated with operating mode of the transmission controller; a notched component with notches corresponding to the P, R, N, D gear positions, and a notch-engaging component associated with the knob for engaging a selected one of the P, R, N, D gear positions to hold the knob in the selected one gear position. The apparatus also includes a feel positioner for providing a feel to a vehicle operator when shifting to any one of the PRND gear positions; and an auto-return-to-park mechanism that automatically returns the knob to the park gear position when the predetermined vehicle conditions are sensed by the transmission controller, the auto-return-to-park mechanism including a release mechanism that releases the feel positioner when the auto-return-to-park mechanism is operating.

In another aspect of the present invention, a shifter apparatus for operating a transmission controller to shift a transmission of a vehicle and to operate the shifter apparatus when a particular vehicle condition is sensed, comprises a gear selector movable between park, reverse, neutral, and drive (P, R, N, D) gear positions associated with operating mode of the transmission controller; a feel positioner for providing a feel to a vehicle operator when shifting to a selected one of the PRND gear positions; a selector control mechanism for controlling movement of the knob in at least the park P gear position; and an auto-return-to-park mechanism that releases the feel positioner from engagement when predetermined particular vehicle conditions are sensed by the transmission controller.

Related methods also form a part of the present invention.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of a first embodiment of the innovative rotary shifter.

FIGS. 2-3 are top and side views of the shifter of FIG. 1, FIG. 4 being an enlarged cross section along line IV-IV in FIG. 2.

FIGS. 5, 6, and 7 are exploded perspective views of FIG. 1.

FIGS. 8-10 are top and two exploded perspective views of the embodiment of FIGS. 1-8, FIG. 8 being a top assembled view with top components eliminated to show its internal configuration, FIG. 9 being an exploded view of FIG. 8 and FIG. 10 being an exploded perspective view of the friction clutch subassembly in FIG. 9.

FIG. 11 is a perspective view of a second embodiment of the innovative rotary shifter.

FIGS. 12-13 are top and side views of the shifter of FIG. 11, FIG. 14 being an enlarged cross section along line XIV-XIV in FIG. 12.

FIGS. 15-17 are exploded perspective views of FIG. 11.

FIGS. 18-19 are top and exploded perspective views of the embodiment of FIGS. 11-17, FIG. 18 being an assembled view with some top components eliminated to show its internal configuration, and FIG. 19 being an exploded view of FIG. 18.

FIG. 20 is a top view similar to FIG. 12 but with some top components (such as its lenz and cap) shown and some top components removed (such as its upper housing removed) to show internal components.

FIGS. 21-22 are partial perspective views showing several internal components and relationships that were hidden in FIG. 20.

FIGS. 23-26 are top views showing shift positions P, R, N, D, respectively, of internal components of the shifter in FIG. 20.

FIGS. 23A-26A are top views corresponding to FIGS. 23-26, respectively, but showing additional internal components of the shifter and their related positions in the various shift positions P, R, N, D.

FIGS. 27-27A are edge and perspective views of the apparatus of FIG. 23 when in a gate-locked park position, the lock component being in a lowered engaged position where it engages the park notch.

FIGS. 28-28A are edge and perspective views of the apparatus of FIG. 23 when in a gate-unlocked position (with components still hovering in the park position, the lock component being in a raised park-notch-disengaged position.

### DETAILED DESCRIPTION OF PREFERRED EMBODIMENTS

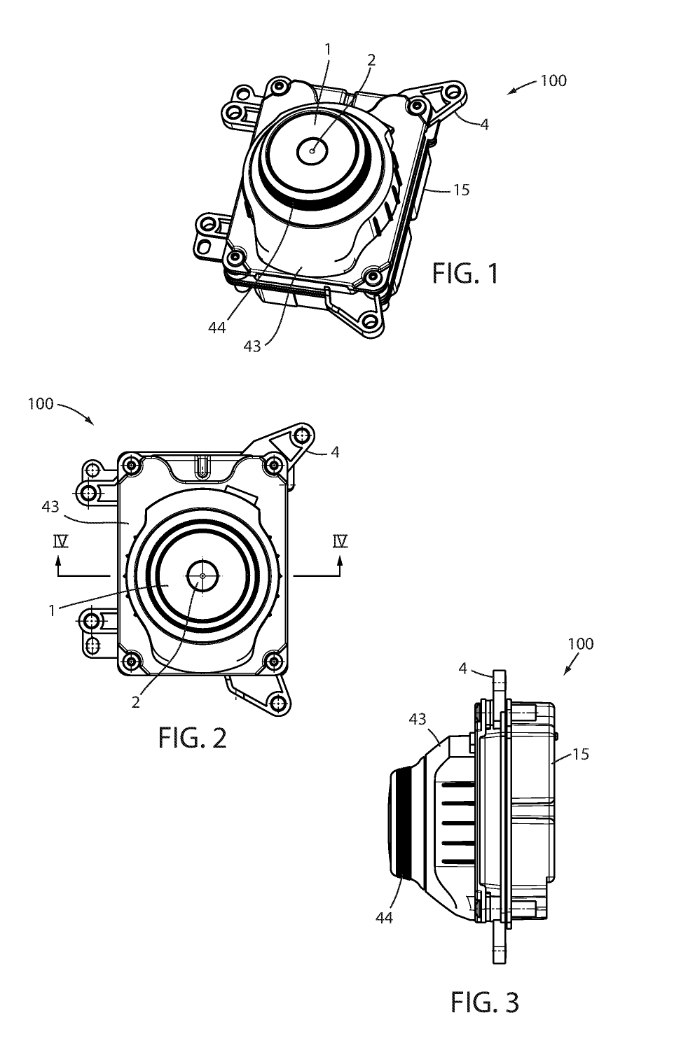

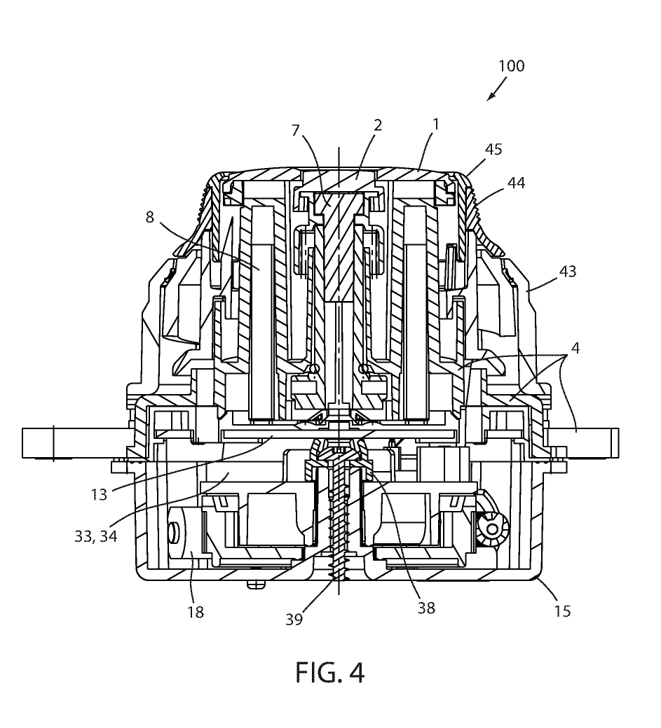

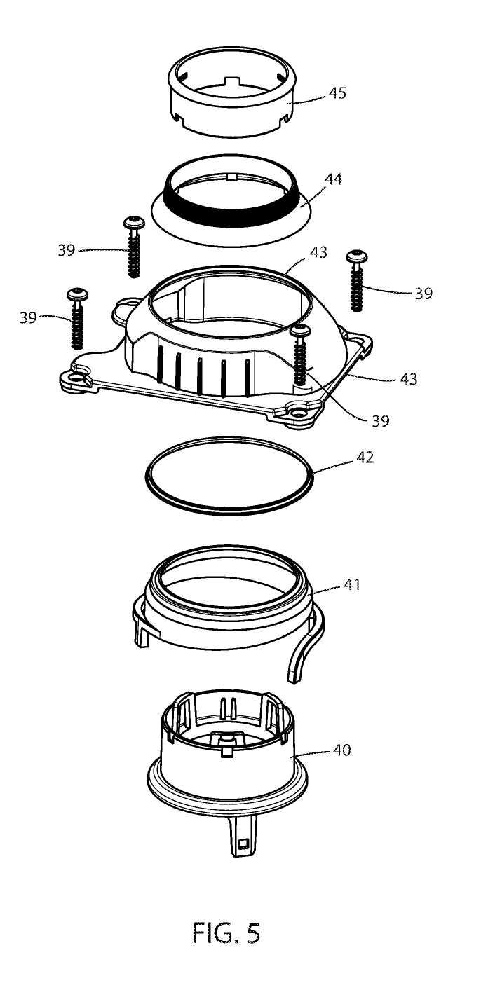

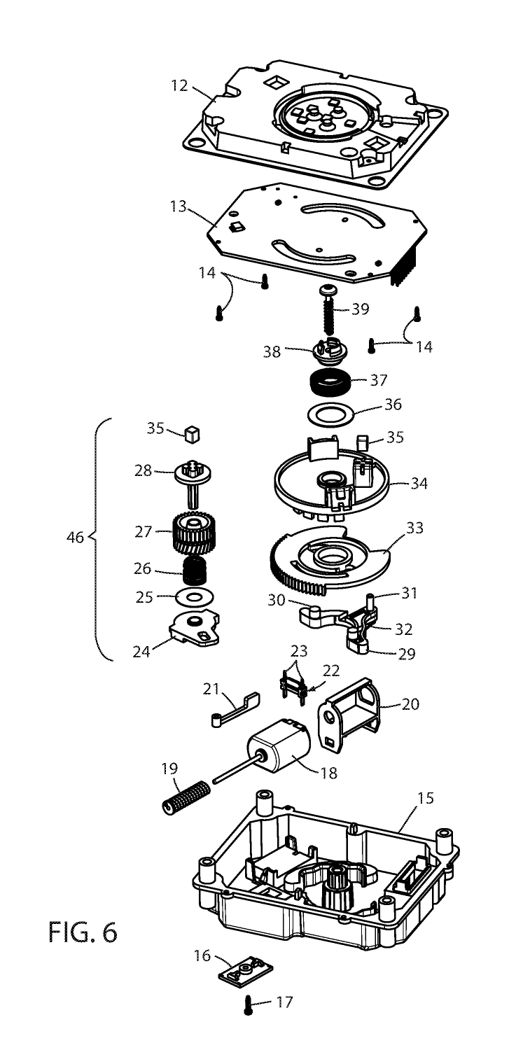

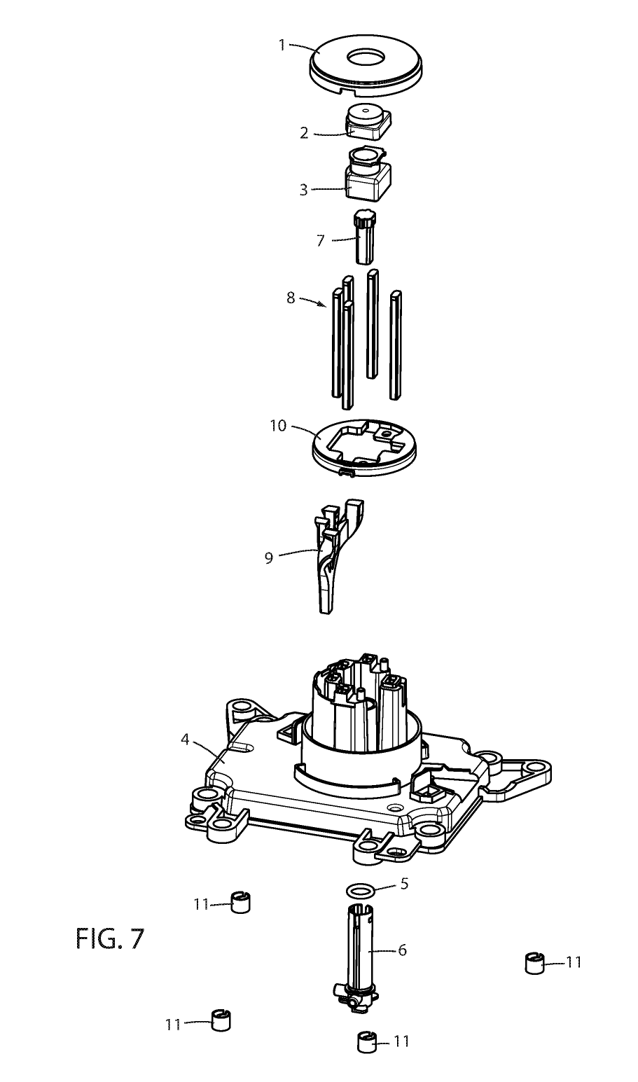

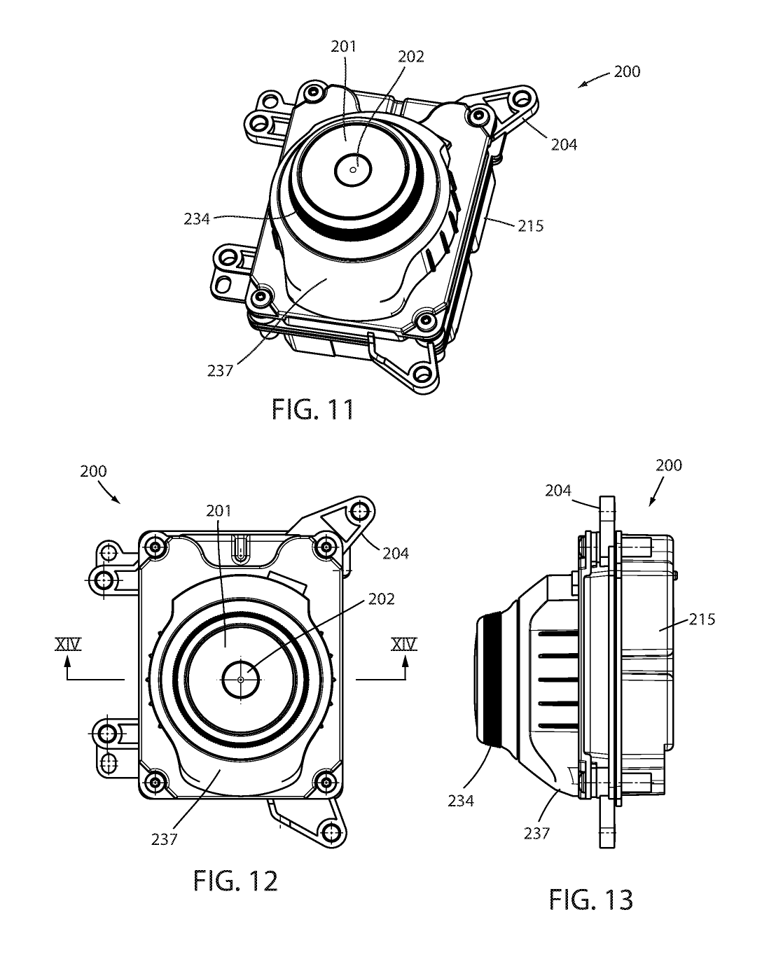

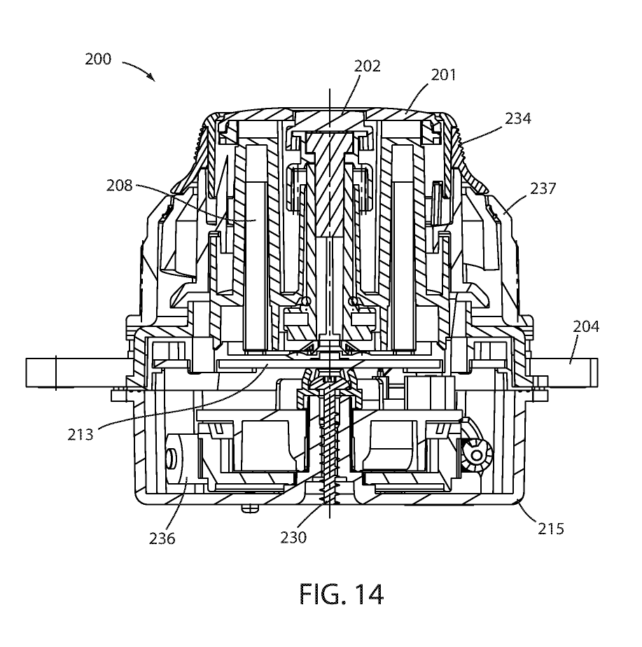

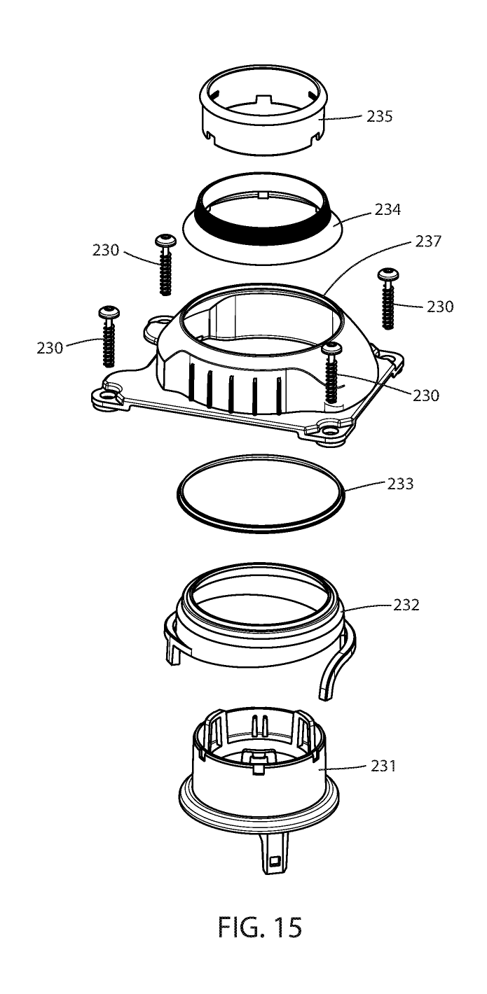

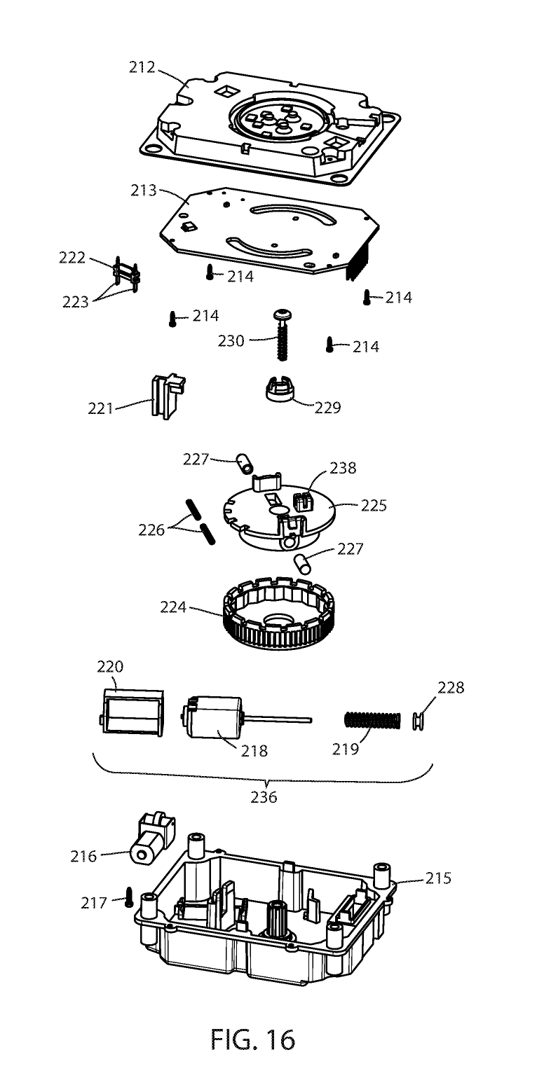

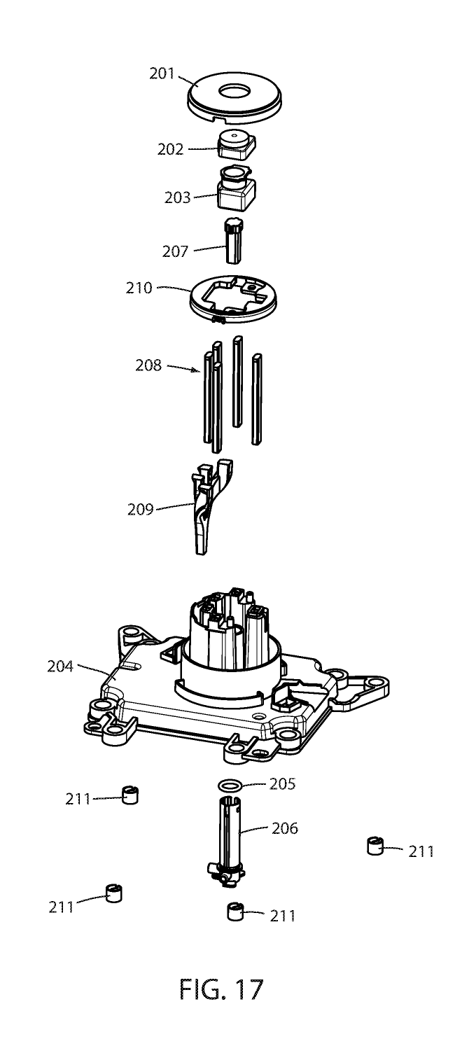

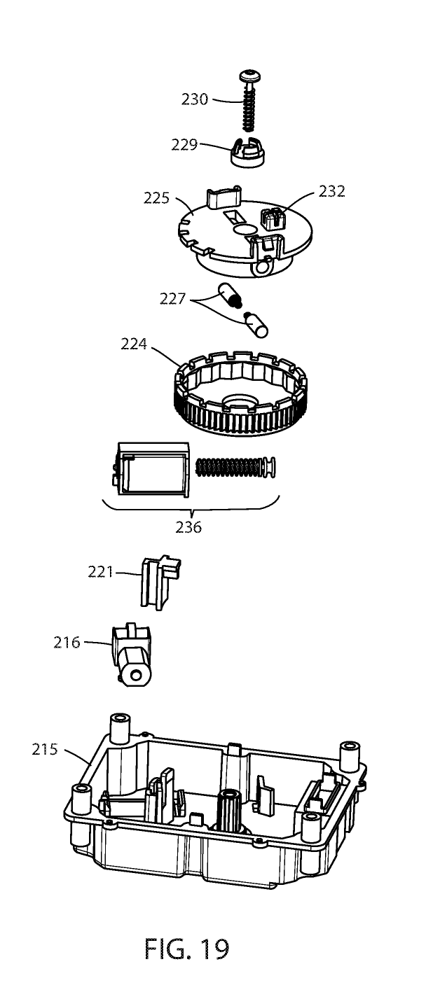

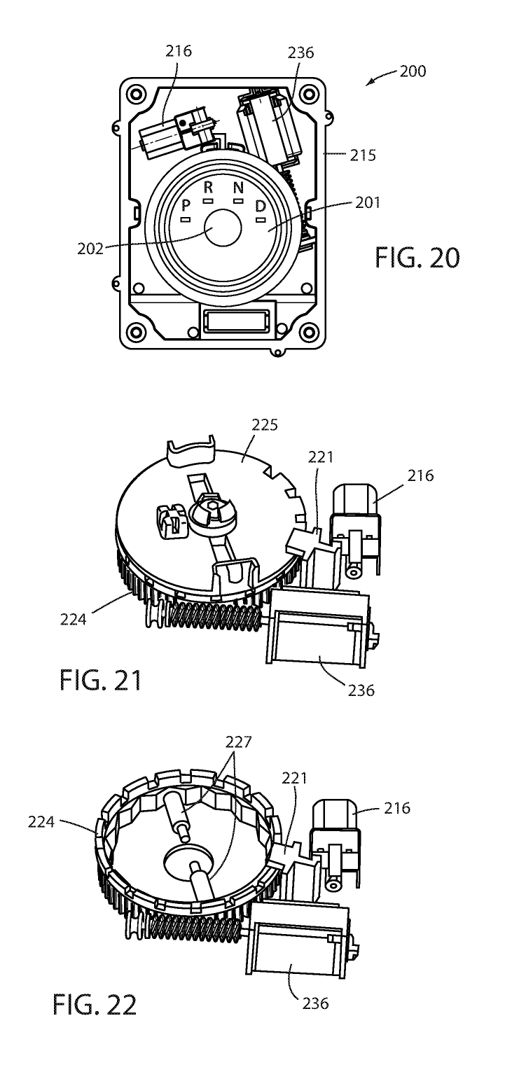

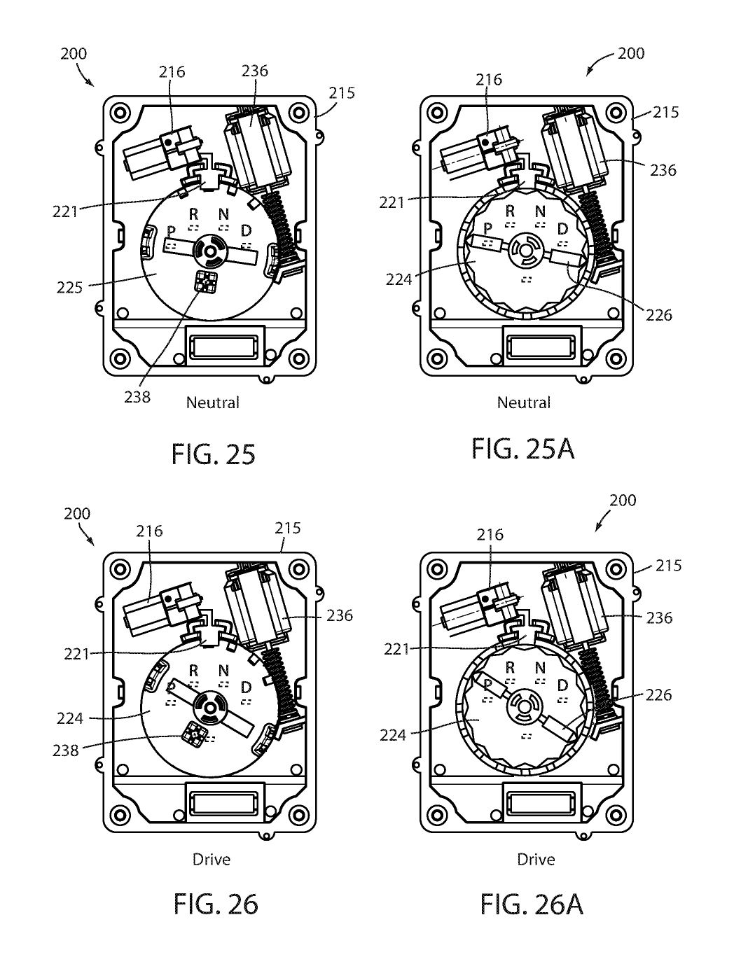

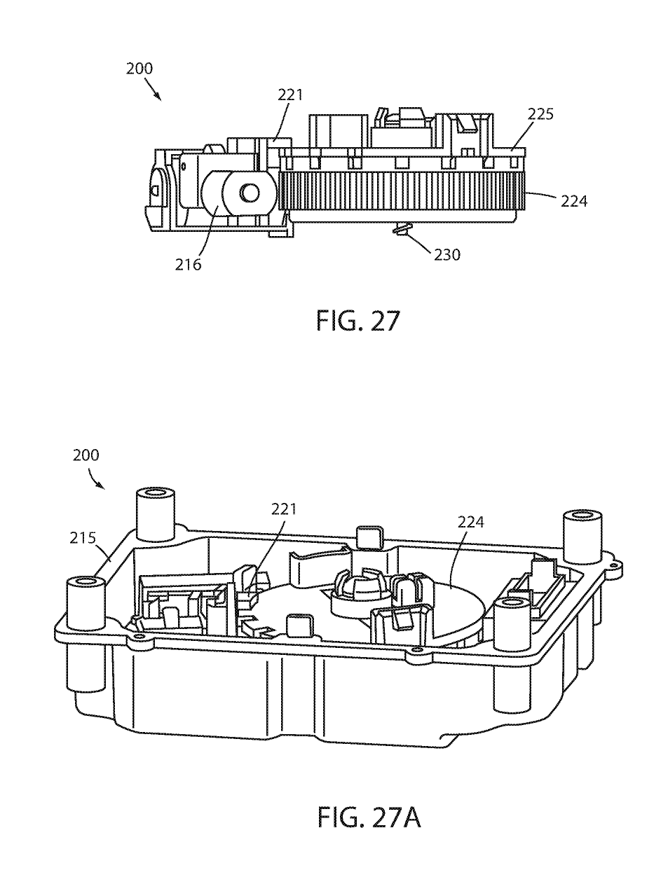

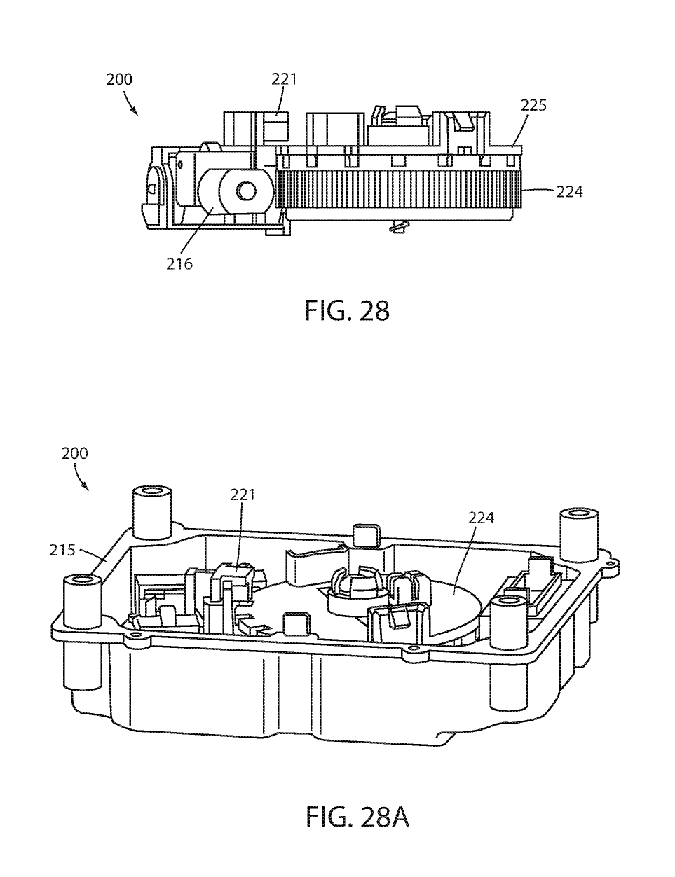

The present shifter apparatus 100 (FIGS. 1-10) and modified apparatus 200 (FIGS. 11-26A) are illustrated, each being configured to operate as a transmission controller of a vehicle. The apparatus 100 and 200 each comprise a selection knob rotatable between a plurality of angular positions for selecting an operating mode of the transmission controller; and a knob-rotation-control mechanism configured to engage the selection knob in at least one of the plurality of angular positions. A motor is operably coupled with the knob-rotation-control mechanism and configured to move a portion of the knob-rotation-control mechanism between at least two positions including a locked position that prevents rotation of the selection knob and an unlocked position that allows rotation of the selection knob. In apparatus 100, the motor (see motor 18) (FIG. 6) is operably connected to a shift-position-indicating detent in a manner causing the bullet detent (29) to release from the corresponding detent surface (i.e. the undulating surface on the lower housing 15) during auto-return of the shift knob (knob body 40 and assembled components) to the park position P, thus eliminating any oscillating (increasing and decreasing) frictional changes during the auto-return. This eliminates increases and decreases in noise and speed associated with the auto-return as it traverses various positions of the feel positioner. In apparatus 200, a motor 218 and linear actuator 216 (FIG. 16) are operated in cooperation during auto-return of the shift knob (knob body 231) in a manner causing the detent bullets (227) to release from the undulating surface on the detent gear 224, thus eliminating any oscillating (increasing and decreasing) frictional changes during the auto-return.

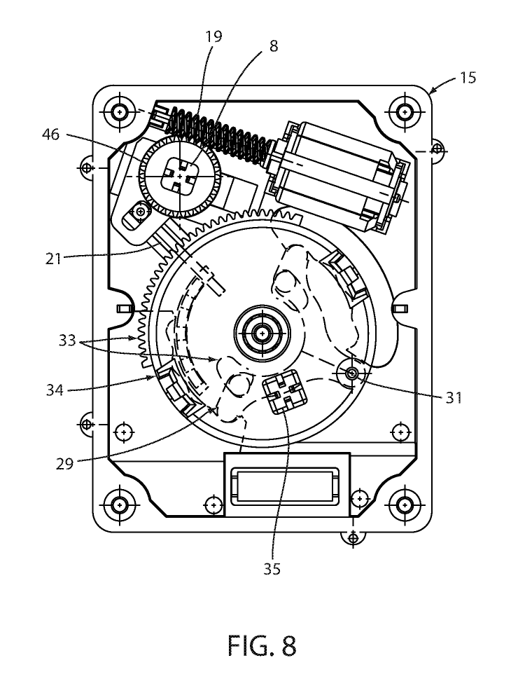

Notably, the apparatus 100 (the first version) includes a gear portion (slide gear 27 of the knob-rotation-control mechanism operably supported/mounted to slide along a defined track on the lower housing (see FIG. 8). The slide gear 27 is translatingly slidable between the knob locked position (where gate lock 21 is engaged), a “partially-moved” knob unlocked position for selecting a gear position (where the gate lock 21 is disengaged), and a “fully-moved” unlocked position where the feel positioner (see detents 29 and undulating mating surface on the lower housing 15 in FIG. 6 where concavities align with P, R, N, D angular positions) is released and thus the knob can be automatically rotated back to park (called an “auto-return-to-park feature”) without the feel positioner causing oscillating frictional forces due to being engaged (called a “feel positioner released condition”) until park position is attained. Notably, apparatus 100 uses a single actuator (motor 18 which operates the worm gear 19 and cooperates with related slide components) to operate several components in a desired sequence to accomplish the automatic knob-rotation function of the knob-rotation-control mechanism.

The apparatus 200 (the second version) includes many components similar to apparatus 100, but apparatus 200 does not include a slide and does include two actuators. Specifically, the illustrated apparatus 200 uses two actuators, one being a motor 218 and one being a linear actuator 216, both used in coordinated fashion to accomplish the desired (similar) shifting function and auto-return function.

The features on the auto-return-to-park position and the feel-positioner-released condition, as noted above, can be important in a rotatable knob shifter. For example, if a vehicle operator stops a vehicle and turns off its ignition switch while the knob is still in a drive position, certain undesired results may result. For example, the vehicle could potentially roll since the vehicle still “thinks” it is in drive gear position (or is shut off) while all components of the shifter are in a drive gear position, which can leave other vehicle components in undesired positions/conditions. The present apparatus automatically returns the knob to the park position if the vehicle is shut off while the knob is still in drive mode, even if power through the ignition switch is turned off. Also, some vehicles are particularly quiet. This has resulted in a condition where, during auto-return-to-park, the motor driving the auto-return makes an undulating noise that alternatingly gets louder and quieter and/or gets higher and lower in pitch (sometimes called a “wow” noise). This noise can be caused by the motor as it works first harder and then with less effort to overcome oscillating (increasing and decreasing) frictional forces during the auto-return, such as will occur if the motor has to overcome uneven forces caused by moving the shifter knob across feel-position-indicator features of a transmission shifter during the auto-return operation. This wow noise can be distracting or unsettling to the vehicle operator, leading to vehicle complaints. The present shifters 100 and 200 eliminate the uneven frictional forces caused by a feel-position device as the shifter is auto-returned to park.

In one form, the shifter apparatus includes a transmission controller to shift a transmission of a vehicle and to operate the shifter apparatus when a particular condition is sensed (such as that a park brake is depressed and the ignition switch is “on”). The apparatus comprises a selection knob rotatable between a first angular position (e.g. R, N, D) and a second angular position (e.g. P) that correspond respectively with a first operating mode and a second operating mode of the transmission controller; and an actuator operably coupled with the selection knob and configured to automatically rotate the selection knob from the first angular position to the second angular position when the particular condition is present. The apparatus further includes a feel-positioner release device which eliminates uneven frictional forces during an auto-return to park operation.

In another form, the shifter apparatus for operating a transmission controller to shift a transmission of a vehicle and to operate the shifter apparatus when a particular condition is sensed, comprises a selection knob rotatable between park, reverse, neutral, and drive (P, R, N, D) gear positions associated with operating mode of the transmission controller; a notched component with notches corresponding to the P, R, N, D gear positions, and a notch-engaging component associated with the knob for engaging a selected one of the P, R, N, D gear positions to hold the knob in the selected one gear position; a feel positioner for providing a feel to a vehicle operator when shifting to any one of the P, R, N, D gear positions; and an auto-return-to-park mechanism that automatically returns the knob to the park gear position when the predetermined vehicle conditions are sensed by the transmission controller, the auto-return-to-park mechanism including a release mechanism that releases the feel positioner when the auto-return-to-park mechanism is operating.

In another form, the shifter apparatus for operating a transmission controller to shift a transmission of a vehicle and to operate the shifter apparatus when a particular vehicle condition is sensed, comprises a selection knob rotatable between park, reverse, neutral, and drive (P, R, N, D) gear positions associated with operating mode of the transmission controller; a feel positioner for providing a feel to a vehicle operator when shifting to a selected one of the PRND gear positions; a knob-rotation-control mechanism for controlling movement of the knob in at least the park P gear position; and an auto-return-to-park mechanism that releases the feel positioner when the particular vehicle condition are sensed by the transmission controller.

A first version of the present apparatus 100 (also called “rotary knob shifter 100” herein) includes the following components as shown in FIGS. 1-7:

| | | |
|---|---|---|
| 47 | 1 | magnet sensor |
| 46 | 1 | friction clutch |
| 45 | 1 | trim ring |
| 44 | 1 | knob dial |
| 43 | 1 | bezel |
| 42 | 1 | glow ring O-ring |
| 41 | 1 | glow ring |
| 40 | 1 | knob body |
| 39 | 5 | bezel screw |
| 38 | 1 | center support |
| 37 | 1 | friction pivot spring |
| 36 | 1 | friction pad |
| 35 | 2 | sensor magnet |
| 34 | 1 | knob gate |
| 33 | 1 | drive gear (also called “cam gear”) |
| 32 | 1 | detent pivot spring |
| 31 | 1 | detent pivot pin |
| 30 | 2 | cam pin |
| 29 | 2 | cam bullet detent |
| 28 | 1 | magnet holder |
| 27 | 1 | slide gear (also called “translatable frictional member” or “gear |
| | | member” or “gear portion of knob-rotation-control mechanism”) |
| 26 | 1 | friction spring |
| 25 | 1 | friction pad |
| 24 | 1 | gear slide (also called “slide member” or “slide-forming |
| | | member”) |
| 23 | 2 | compliant pin |
| 22 | 1 | compliant pin retainer |
| 21 | 1 | gate lock |
| 20 | 1 | motor mount isolator |
| 19 | 1 | work gear |
| 18 | 1 | lock return motor |
| 17 | 1 | McMaste-Carr screw |
| 16 | 1 | slide trap |
| 15 | 1 | lower housing |
| 15’ | 1 | undulating surface (with concavities for feel positioner detents) |
| 14 | 4 | PCB retention screw (print circuit board's screw) |
| 13 | 1 | gear-selector-member printed-circuit-board assembly (GSM PCB |
| | | ASSY) |
| 12 | 1 | dome pad cover |
| 11 | 4 | creep collar |
| 10 | 1 | lens support |
| 9 | 1 | PRND light pipe |
| 8 | 5 | telltale light pipe |
| 7 | 1 | S-button light pipe |
| 6 | 1 | O-ring plunger |
| 5 | 1 | plunger |
| 4 | 1 | upper housing |
| 3 | 1 | skirt |
| 2 | 1 | cap (including low button cap and/or sport button cap) |
| 1 | 1 | indicator lens |

Several of the components, relationships, and operating positions for the apparatus 100 are shown in FIGS. 8-10, with key components being:
19 worm gear
46 friction clutch
21 gate lock
33 cam gear
34 gear position selector
2 detent fingers
35 magnet sensor
15 lower housing with detent pattern
38 center support
39 bezel screws

In shifter 100 (FIG. 8), stepping on the vehicle's brake causes the vehicle's electronics to actuator the motor 18 to rotate the worm gear 19 to slide the friction clutch 46 along a track in the lower housing, which pushes gate lock 21 into a gate release position (just before its gear teeth contact/engage). The gate release position is sensed by the magnet holder 28. The friction clutch 46 does not engage the drive gear 33 at this point. The gate knob 34 is now able to freely rotate clockwise to select a desired gear position P, R, N, D (position-sensed by the sensor magnet 47 via sensing a position on the GSM PCB assy 13). The friction clutch 46 (via its detent fingers pinned to gate knob 34) provide a detent feel from the undulating detent pattern on the lower housing 15. Rotating the lower housing 15 also rotates drive gear 33 via timed gate features in both.

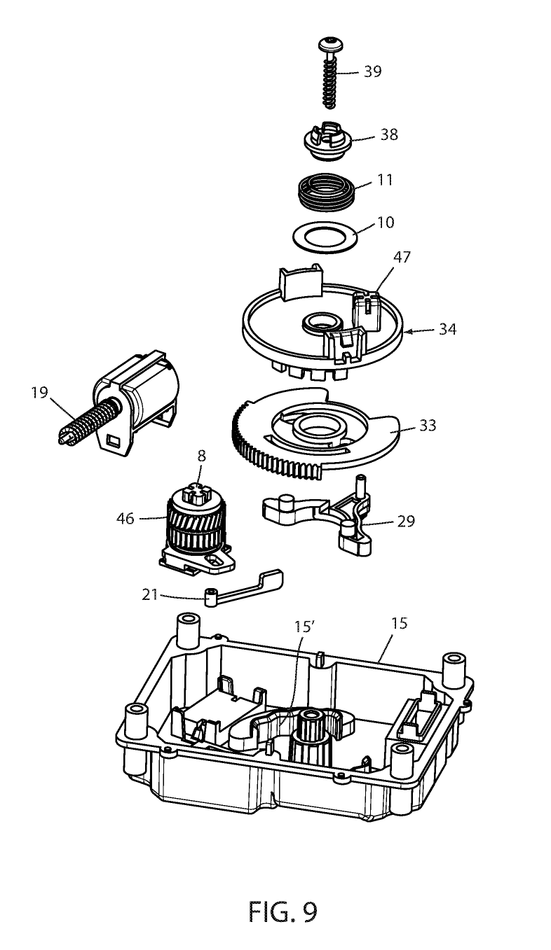

Upon return to the Park position P, the motor further rotates the worm gear 19 to slide the friction clutch 46 into engagement with drive gear 33. The friction clutch 46 now allows rotation of the gear on friction clutch 46 to rotate counter clockwise the drive gear 33, which in turn moves the cam on the drive gear 33 to pull cam bullet detent 29 inward where it is released from detents on the lower housing 15 (see FIG. 9). Through timed gate features in Drive gear 33 and knob gate 34, the knob 34 rotates counter clockwise until reaching park position P, at which point the motor 18 reverses rotation of the worm gear 19 causing disengagement of the friction clutch 46 from the drive gear 33. The friction clutch 46 and gate lock 21 slidingly move back to their respective gate lock positions. Simultaneously, the cam bullet detent bullet 29 will move (via spring bias) out to and engage against the corresponding detent in the undulating detent surface in the lower housing 15.

Regarding FIG. 9, the assembly including motor 18 and worm gear 19 are operably connected to the GSM PCB assy 13 which is programmed to hold the cam gear, detent fingers, knob gear, friction spring and friction pad to a set height during return to park and during cam operation. It is noted that the motor 18 has sufficient power and operating characteristics to overcome frictions of the entire system, and to provide the durability and robustness needed for operation of the system of apparatus 100.

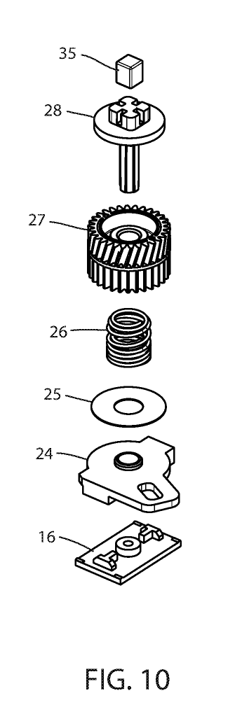

Regarding FIG. 10, the friction pad and spring product enough resistance to rotation to overcome sliding friction and thus allow (cause) linear travel of the gear slide assembly. Then, when gears are engaged and slide travel is stopped, the friction of rotation is less than that causing travel to stop. At that time, the slide gear rotates to rotate the cam gear (drive gear 33) and thus causing the cams to pull detent fingers (cam bullet detent 29) inward and through timed stop gates. This also rotates the knob (i.e. knob body 40 and assembled components) back to park position P without any detent action (i.e. the cam bullet detents 29 don't contact the detent pattern on the lower housing 15 during this rotational travel . . . i.e. the feel positioner is disengaged). After park position P is sensed via the magnet sensor 35, the motor's direction (i.e. motor 18) is reversed, returning the slide gear 27 back to its starting position and moving the gate lock 21 into its locked position, thus locking the knob in the park position P.

A modified (second) version of the present apparatus (also called “rotary knob shifter 200” herein) includes the following components in FIGS. 11-17:

| | | |
|---|---|---|
| 238 | 1 | position sensor magnet |
| 237 | 1 | bezel (also called “upper housing”) |
| 236 | 1 | worm gear and motor assembly (worm gear on shaft of |
| | | reversible dc motor) |
| 235 | 1 | trim ring |
| 234 | 1 | knob dial |
| 233 | 1 | glow ring O-ring |
| 232 | 1 | glow ring |
| 231 | 1 | knob body |
| 230 | 5 | bezel screw |
| 229 | 1 | center support |
| 228 | 1 | O-ring mount |
| 227 | 1 | detent bullet |
| 226 | 2 | plunger spring |
| 225 | 1 | gate detent |
| 224 | 1 | detent gear |
| 223 | 2 | compliant pin |
| 222 | 1 | compliant pin retainer |
| 221 | 1 | gate lock |
| 220 | 1 | motor mount isolator |
| 219 | 1 | worm gear |
| 218 | 1 | lock return motor |
| 217 | 1 | McMaste-Carr screw |
| 216 | 1 | linear actuator |
| 215 | 1 | lower housing |
| 214 | 4 | PCB (printed circuit board) retension screw |
| 213 | 1 | gate-selector-member printed circuit board assy (GSM PCB ASSY) |
| 212 | 1 | dome pad cover |
| 211 | 4 | creep collar |
| 210 | 1 | lens support |
| 209 | 1 | PRND light pipe |
| 208 | 5 | telltale light pipe |
| 207 | 1 | S-button light pipe |
| 206 | 1 | O-ring plunger |
| 205 | 1 | plunger |
| 204 | 1 | upper housing |
| 203 | 1 | skirt |
| 202 | 1 | cap (low button cap and/or sport button cap) |
| 201 | 1 | indicator lens |

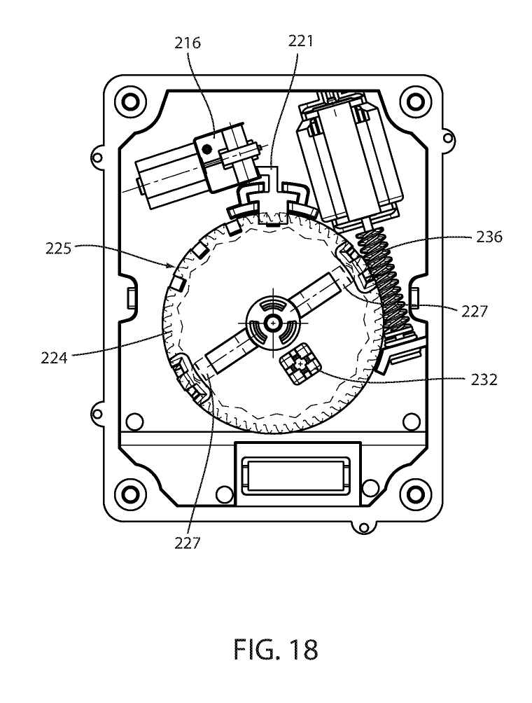

Several of the components, relationships, and operating positions for the present apparatus 200 are shown in FIGS. 18-26A, with key components being:
221 gate blocker
225 detent gate
224 detent gear
227 detent bullets
232 magnet sensor
236 motor and worm gear assy
216 gate lock motor
215 lower housing
229 center support
230 bezel screw

As shown in FIG. 18, stepping on the vehicle's brake causes the vehicle's electronics to release the gate lock 221 (moving it from its gate locked position), moving the gate lock 221 vertically via the linear actuator 216. This allows rotation of the gate detent 225 which is detected by movement of the magnet sensor 238 (which is on detent gate 225) relative to the GSM PCB assy 213. Detent gear 224 remains stationary during this time, held by motor and worm gear and motor assembly 236, until a return-to-park operation is performed.

Upon return to park activation, the gate lock 221 (moved via linear actuator 216) releases the gate detent 225. The motor 218 rotates worm gear 219 causing the detent gear 224 to rotate counterclockwise which through friction from detent bullet 227 also rotates gate detent 225 back to park position P and then locks gate lock 221 into the park gate slots in both the gate detent 225 and the detent gear 224. A magnet in gate lock 221 senses a height of the gate lock 221. If there is mismatch between the gate detent 225 and the detent gear 224, the gate lock 221 will not find proper locked height. Software in the vehicle electrical system and/or the GSM PCB assy 213 is programmed to resolve any mismatch of the desired detent and knob positions and thus affirm that gate locking has (fully and properly) occurred in the park position P.

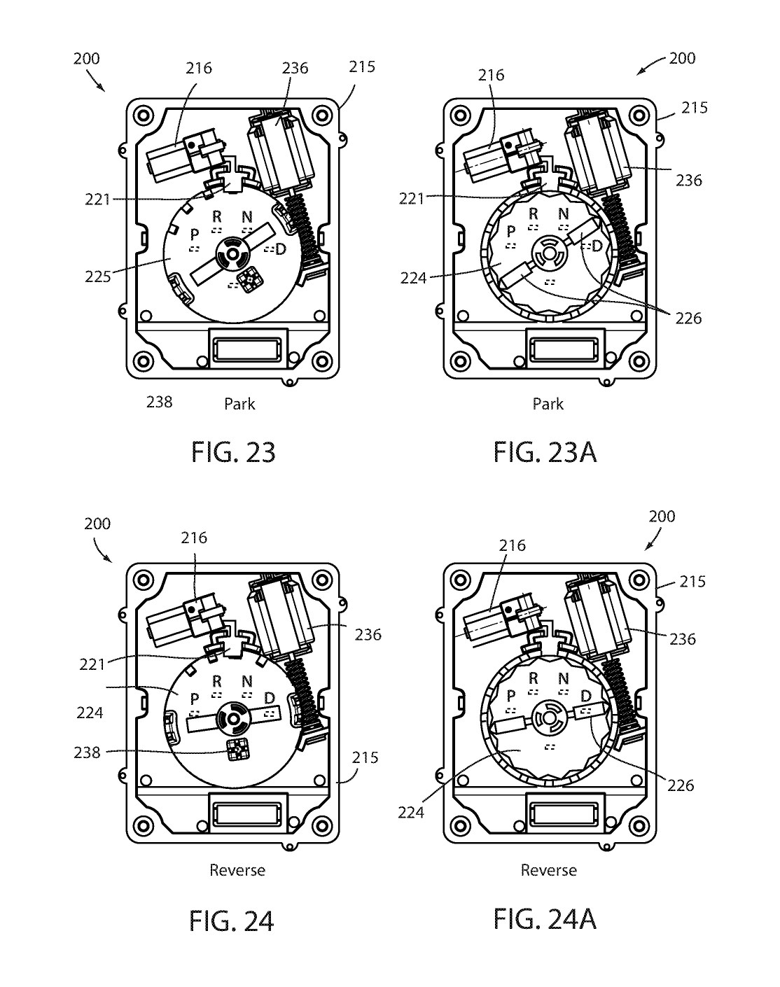

A position of various components in assembly 200 is shown in FIGS. 23-26 (and in FIGS. 23A-26A) in the various gear positions: park P, reverse R, neutral N, and drive D, respectively.

It will be apparent to those skilled in this art that the illustrated embodiments use a lot of identical components and many similar components (similar in shape and/or function). In particular, compare FIGS. 1, 4-7 showing the first embodiment with FIGS. 11, 14-17 showing the second embodiment.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A shifter apparatus for operating a transmission controller of a vehicle, comprising:
a selection knob rotatable between a plurality of angular positions for selecting an operating mode of the transmission controller;
a knob-rotation-control mechanism configured to engage the selection knob in at least one of the plurality of angular positions; and
at least one actuator operably coupled with the knob-rotation-control mechanism and configured to slide a slidable portion of the knob-rotation-control mechanism between at least two positions including a locked position that prevents rotation of the selection knob and an unlocked position that allows rotation of the selection knob.

2. The shifter apparatus of claim 1, including a housing defining a track, and wherein the slidable portion is operably slidably support for translational movement along the track.

3. The shifter apparatus of claim 1, wherein the slidable portion of the knob-rotation-control mechanism includes at least one gear.

4. The shifter apparatus of claim 1, wherein the knob-rotation-control mechanism includes a friction clutch operably engaged with the slidable portion.

5. The shifter apparatus of claim 1, wherein the at least one actuator includes a reversible motor.

6. A shifter apparatus for operating a transmission controller of a vehicle for shifting a vehicle transmission between gear positions, comprising:
a selection knob rotatable between a plurality of angular positions for selecting an operating mode of the transmission controller, the operating mode controlling selection of a desired one of the gear positions;
a knob-rotation-control mechanism configured to engage the selection knob in at least one of the plurality of angular positions; and
at least two actuators operably coupled with the knob-rotation-control mechanism and configured to sequentially operate to rotate the knob-rotation-control mechanism between at least two positions including a locked position that prevents rotation of the selection knob and an unlocked position that allows rotation of the selection knob.

7. The shifter apparatus of claim 6, wherein the at least two actuators includes a linear actuator.

8. The shifter apparatus of claim 7, wherein the at least two actuators includes a reversible motor.

9. A shifter apparatus for operating a transmission controller to shift a transmission of a vehicle and to operate the shifter apparatus when a particular condition is sensed, comprising:
a selection knob rotatable between angular positions that correspond respectively with P, R, N, D operating modes of the transmission controller and that in turn correspond with P, R, N, D gear positions of the transmission;
a notched component with notches corresponding to the P, R, N, D gear positions, and a notch-engaging component associated with the knob for engaging a selected one of the P, R, N, D gear positions to hold the knob in the selected one gear position; and
at least two actuators operably coupled to the selection knob and the notched component that are configured to disengage the notch-engaging component from the knob when a particular vehicle condition is met and also to then rotate the selection knob from the one angular position corresponding to the selected one gear position to another one of the angular positions.

10. The shifter apparatus of claim 9, wherein the at least two actuators includes a linear actuator.

11. The shifter apparatus of claim 9, wherein the at least two actuators includes a reversible motor.

12. A shifter apparatus for operating a transmission controller to shift a transmission of a vehicle and to operate the shifter apparatus when a particular condition is sensed, comprising:
a base;
a selection knob rotatable on the base between park, reverse, neutral, and drive (P, R, N, D) gear positions associated with an operating mode of the transmission controller;
a notched component with notches corresponding to the P, R, N, D gear positions, and a notch-engaging component associated with the knob for engaging a selected one of the P, R, N, D gear positions to hold the knob in the selected one gear position;
feel positioner with undulations corresponding to the P, R, N, D gear positions for providing a feel to a vehicle operator when shifting to any one of the P, R, N, D gear positions; and
an auto-return-to-park mechanism that automatically returns the knob to the park gear position when the predetermined vehicle conditions are sensed by the transmission controller, the auto-return-to-park mechanism including a release mechanism that releases the feel positioner from the undulations when the auto-return-to-park mechanism is operating.

13. A shifter apparatus for operating a transmission controller to shift a transmission of a vehicle when particular vehicle conditions are sensed, comprising:
a gear selector movable between gear positions associated with operating mode of the transmission controller;
a feel positioner providing a feel to a vehicle operator when shifting the gear selector to a selected one of the gear positions;
a selector-control mechanism for controlling movement of the gear selector in at least one of the gear positions; and
an auto-return-to-park mechanism constructed to selectively automatically move the gear selector when specific vehicle conditions are sensed and that releases the feel positioner when the predetermined particular vehicle conditions are sensed by the transmission controller.
